(19) United States
(12) Patent Application Publication
(10) Pub. No.: US 2010/0004972 A1
(43) Pub. Date: Jan. 7, 2010

(54) Resource Management

(75) Inventors: Orit Harel, Kadima (IL); Malkiel Hadari, Hod Hasharon (IL); Ziv Holzman, Tel-Aviv (IL); Bernd Ernesti, Wiesloch (DE); Stefan Grabowski, Osthofen (DE)

Correspondence Address: IP STRATEGIES, 12 1/2 WALL STREET, SUITE E, ASHEVILLE, NC, 28801, US

(73) Assignee: SAP AKTIENGESELLSCHAFT, Waldorf (DE)

(21) Appl. No.: 11/721,909

(22) PCT Filed: Dec. 15, 2004
(86) PCT No.: PCT/EP2004/053486

§ 371 Date: Sep. 25, 2009

(51) Int. Cl. G06Q 10/00; G06Q 50/00

(52) U.S. Cl. 705/9; 705/7; 705/8

(57) ABSTRACT

The invention provides a computer-implemented warehouse order processing method, whereby a warehouse order specifies work which is to be executed by a resource at a warehouse, a resource representing a physical entity which is able to execute work; during creation of a warehouse order, performing a step of determining a number of parameters relevant for execution of the respective warehouse order, and storing the determined parameters in a data base; during selection of a warehouse order for execution by a resource, performing a step of analyzing relevant population of warehouse orders for execution by the requesting resource, on the basis of the determined parameters, whether the selected resource is able to execute the warehouse order, and upon execution of a warehouse order by a resource, updating the data base comprising, the parameters for the warehouse orders.

### BACKGROUND OF THE INVENTION

This application relates to warehouse management in general, and in particular to management of human and technical resources in a warehouse. The resources work in the warehouse. The work to be executed by the resources comprises activities such as transferring goods from one location in the warehouse to another location. The human resources may work with or without tools (in the following denoted as equipment) such as forklifts or pallet jacks for executing the activities. There may be purely technical resources like autonomous transport vehicles which work without human manipulation.

A resource management system is a computer-implemented system which is used to control the activities of the resources in the warehouse. Typically, there is a warehouse supervisor or manager who oversees the activities of the resources in the warehouse.

The most common objectives are maximizing productivity and minimizing operation costs subject to time constraints. In order to achieve these objectives, the warehouse manager is required to manage the warehouse resources in an efficient manner.

### SUMMARY OF THE INVENTION

It is an object of the invention to provide a method and system which give a comprehensive view over the resources with various qualifications, special execution requirements, time constraints and resource workload.

In one aspect, this invention provides a computer-implemented warehouse order processing method, whereby a warehouse order specifies work which is to be executed by a resource at a warehouse, a resource representing a physical entity which is able to execute work; during creation of a warehouse order, performing a step of determining a number of parameters relevant for execution of the respective warehouse order, and storing the determined parameters in a data base; during selection of a warehouse order for execution by a resource, performing a step of analyzing relevant population of warehouse orders for execution by the requesting resource, on the basis of the determined parameters, whether the selected resource is able to execute the warehouse order, and upon execution of a warehouse order by a resource, updating the data base comprising the parameters for the warehouse orders.

A resource may be one single user, single warehouse equipment, and user who operates a predefined equipment

The parameters relevant for execution of the warehouse order may comprise at least one of:
resource types which are qualified to execute the respective warehouse order,
execution environment of the respective warehouse order,
prioritization of the respective warehouse order,
last starting date of execution of the respective warehouse order, and
status of the respective warehouse order.

In a further embodiment of the invention, each resource may be logged on, and logged off in a warehouse management system.

Hereby, at logon of a user with a work equipment, it may be verified whether the user is allowed to operate the work equipment.

A logoff of a user, it may additionally be verified whether or not the user has completed the warehouse orders assigned to him.

In all embodiments of the invention, warehouse orders may be selected based on a number of predefined parameters.

Furthermore, warehouse orders may be assigned to a resource for execution upon request of the resource.

Furthermore, warehouse orders may be assigned to a resource for execution manually.

As an alternative, warehouse orders may be assigned to a resource for execution automatically.

In a further embodiment of the invention, assignment of a warehouse order to a resource may be transmitted via RF communication and outputted on an RF device which is associated with the resource.

In all embodiments of the invention, messages may be sent to predefined resources via RF.

Logged-on resources may be monitored at a central position.

Workload for a given resource may be monitored at a central position.

Warehouse orders assigned to a resource may be automatically recovered after execution interruption to allow further execution.

The invention further comprises a computer-readable storage medium comprising program code for performing the method according to the invention as described above, when loaded into a computer system.

One of the advantages is that the present invention provides simplification of customization and processes, usage of resources for stock keeping, efficient selection process, which is time critical, as well as an enhanced queue management.

### BRIEF DESCRIPTION OF DRAWINGS

FIG. 1 illustrates the concept of queues in warehouse management;

FIG. 2 illustrates the sequence of steps of inventive method;

FIG. 3 illustrates a more detailed view of an embodiment of the present invention;

FIG. 4 illustrates a use case model;

FIG. 5 gives an example for computing the calculation of a priority parameter;

FIG. 6 illustrates an example for a bin access type; and

FIG. 7 illustrates an example for a handling unit type group.

### DETAILED DESCRIPTION

First, some definitions of terms are given which are used in connection with the present invention.

Resources—Resources are the entities which execute the work in the warehouse. A resource can be a single user, a single equipment or a user who operates equipment Generally, resources are needed for stock keeping during the processing of a transfer order (TO) for work selection, for monitoring resource work and performance, and for resource planning.

Resource type—Resource type is used for grouping of resources by similar technical or physical qualifications. For instance: Resources FORK1, FORK2 and FORK 3 are associated with resource type forklift, whereas resources PALLET1 and PALLET2 are associated with resource type pallet jack.

Warehouse order (WHO)—A WHO specifies work to be executed by a resource in the warehouse.

Supervisors/managers—Supervisors or managers oversee the activities of the resources in the warehouse. Means are provided to monitor the resources, and to communicate via messages with the resources.

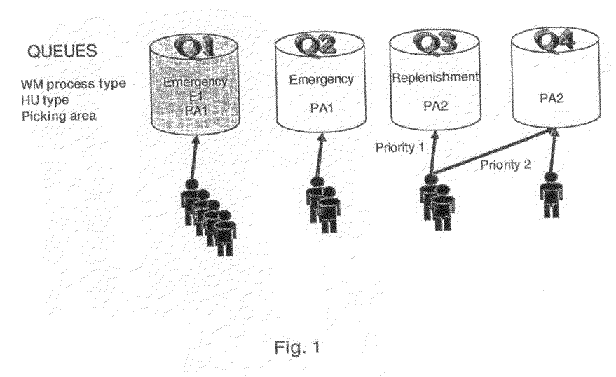

Queue—Queues define movements by which the work in the warehouse is managed and assigned. The queues are defined based on qualifications and managerial rules that reflect the required warehouse operation behavior. FIG. 1 illustrates this concept.

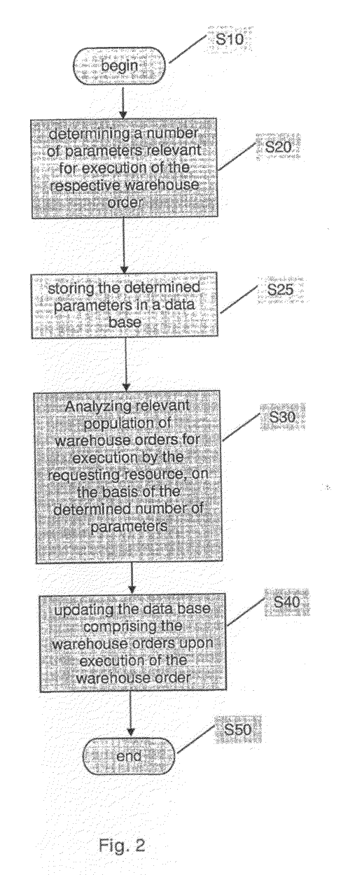

In the following, the method of the invention is described with reference to FIG. 2. After begin in step 10, during creation of a warehouse order, a step 20 is performed wherein a number of parameters relevant for execution of the respective warehouse order is determined.

In step 25, the determined parameters are stored in a data base.

Further, a step 30 is performed of analyzing relevant population of warehouse orders for execution by the requesting resource, on the basis of the determined parameters. This verification relates in particular to physical capabilities and to managerial preferences.

Upon execution of a warehouse order by a resource, a step 40 of updating the data base comprising the parameters for the warehouse orders is performed.

The method ends in step 50.

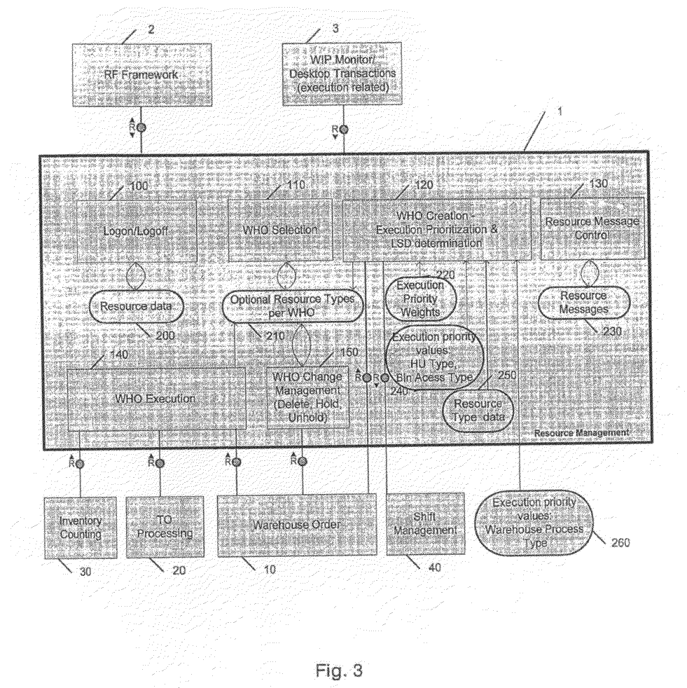

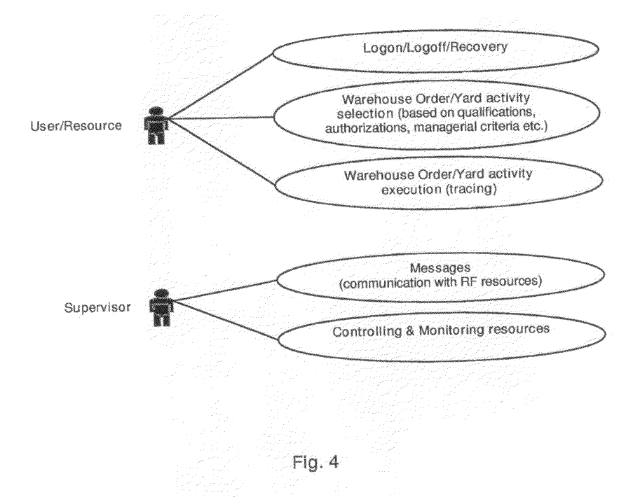

The functionalities of a resource management which implements the inventive methods are described with reference to FIG. 3, and FIG. 4.

Logon/logoff 100—Resource management enables intuitive and simple logon. The system provides logon procedures for the different kinds of resources:
A user who operates without equipment.
Automatic equipment which operates without a user.
A user who operates with equipment (e.g. forklift driver who operates with a forklift). In such a scenario, the logon functionality verifies if the user is allowed to operate the equipment. Users may be enabled to logon to multiple equipments simultaneously.

The logon is traceable from time and resource perspectives, to enable monitoring the active resources. Logoff can be done after complete or partial WHO confirmation. The user specifies the reason code for logging off (not mandatory and may decide to leave WHOs assigned or un-assigned). Another option is to determine whether to leave the WHOs assigned to the user automatically based on the logoff reason code.

The logoff is also traceable. The system traces status change, reason code and timestamp. At logoff, users and equipments are detached.

WHO selection 110—WHO selection is enabled in both RF and non-RF environments. The process takes into consideration parameters such as: assigned queues (by sequence), assigned WHO, WHOs priorities, last starting date (LSD), resource type qualifications and statuses of WHOs. Hereby, the goal is to achieve high performance in the selection process, since it is time critical in the warehouse operation.

WHO execution 140—Execution tracing is enabled at WHO level to indicate the resource, which executed the WHO. The details of the execution can be traced at the lowest entity level.

User/resource messages 230—Pushing messages provides a convenient communication method of managers with RP users. The message is presented to the user following the next key stroke.

Resource controlling and monitoring—Views for analyzing resource workload and monitor resource execution are provided. In addition, the warehouse manager is provided with tools to enable control of resources and their workload.

Recovery—An RF resource which is assigned to WHO gets the assigned WHO after recovery, to allow further execution continuation. In case where no WHO is assigned, to the resource, the resource may select a new WHO.

Again taking reference to FIG. 3, the function units of the warehouse management system are described in more detail.

Upon logon, functionality tracking warehouse resources, stock on resources and WHO selection may be started. Logging on to the system is a prerequisite for logging on to a particular application. The goal is to enable automatic application logon if possible. Automatic Logon can be achieved if all the mandatory parameters are predefined. In that case, the logon will be processed in the background and will be seamless to the user.

The logon unit 100 in RF environment is initiated by the user using a physical transaction. It is addressed to the resource management system 1 by the RF framework 2. The resource management system 1 fetches the following information to the RF framework:
User related profiles: Personalization profile, presentation profile;
Presentation device, if the presentation device does not identify itself and if the user did not specified the presentation device manually.

A user logs on to a resource, which may represent an equipment or the user himself (if no equipment is required).

An integral part of the logon process is authorization check by resource type. This authorization object determines whether the user is allowed to operate the resource type to which he/she attempt to logon.

One user may be allowed to logon to multiple resources simultaneously. The logon process is traced as a resource status in a log table. Once the user logged on to the application, he/she becomes an active resource which can request and execute work in the warehouse.

In non-RF environment, users may be logged on to resources by the warehouse manager using the monitor. Logon is recommended for tracking warehouse resources and control WHO selection. In case where no logon is utilized, the worker is represented as a resource with no user assignment.

The automatic logon may be triggered either by the presentation device or by the user.

Scenario 1—Triggered by the presentation device: This scenario is accomplished by the ability of the presentation device to identify itself. The application uses this identification to determine the default resource. User related parameters are determined based on a predefined user default data table. In this scenario the automatic logon may be established in case where the following conditions are satisfied:
The presentation device can identify itself.
Default resource is assign to the presentation device. This scenario is typically used for presentation device which is mounted on equipment or any case of 1:1 relationship between presentation device and equipment.
Default warehouse is defined for the user in the user default data table.

Scenario 2—Triggered by the user This scenario is accomplished by predefined default parameters, which are assigned to the user who logged on to the system (e.g. SAP R/3). One of the mandatory default parameters for utilizing this scenario is the resource. The default resource determines the default presentation device.

This scenario may be established in case where the following conditions are satisfied:
Default resource and warehouse are defined for the user in the respective table.
Default presentation device is defined for the default resource in a particular table.

Since the user may logon to multiple resources or use in some occasions different presentation device, the automatic logon is enabled in different variations. In the user table, automatic logon is a flag, which indicates if the automatic logon is mandatory. If this flag is raised and all the default parameters were defined, then the user will be logged on automatically, skipping the display of the logon screen. In that case multiple logons are not possible. If the flag is not raised, the logon screen will be presented to the user. The default parameter's values will be presented on the screen. The user may logon with these values or use the pushbutton of “Clear All” to logon with different values. In case where the user wishes to log on to multiple resources or to specify different parameters than the default, he/she can enter the required data in the logon screen.

Manual Logon—Logon requires determination of warehouse, resource and presentation device. In case one of these parameters is not defined as default, manual logon is provided. The user identifies the resource to which he logs on. In case he does not operate any equipment, he will identify his own user. This user must be defined as a resource in the corresponding resource table. A default presentation device may be defined for the resource. This default will be filled out automatically in the appropriate field of the logon screen. The user is able to override this default The personalization profile is determined for the user in the user table.

Recovery—Recovery is initiated by activation of a so-called master logical transaction. Its initial step is logon, which is linked to logon FM. This FM addresses the logon request to the resource management system, which identifies if the user was previously logged on using the resource table. If such a scenario is identified, the next check determines if a specific WHO that was assigned to the resource was stopped before completion. If so, resource management package will fetch the information of the last logical transaction that was used by the resource table.

Each logical transaction determines two initial steps: one step for standard process and one step for recovery. In case where a recovery scenario was identified, the logical transaction should start from the initial recovery step, which analyzes the status of the document within the overall transaction and determines the step and function code to continue with The initial recovery step should be linked to FM of the relevant content provider.

In case where multiple WHOs were stopped before completion, the user has to choose the required WHO and determine if he continues with the same resource. The user has also an option to select a new presentation device for the same resource.

If no WHO is assigned to the user, the user gets the logon screen. The screen displays a pushbutton/function key to enable continuation with the resource/s he was logged on to. In case the user chooses to utilize this option, if he was logged on to multiple resources, he would have to specify the required resource. The option to select a new presentation device is available too. If the user was logged on to a single resource he is logged on to the resource (with the same or different presentation device) and the appropriate menu is displayed. In addition, the user has the option to logon to a new resource, by entering the relevant information in the logon screen.

Warehouse order selection 110—WHO selection 110 is a process that has a great impact over the execution in the warehouse. It considers a comprehensive set of parameters to ensure that the operational warehouse goals will be achieved. The parameters that should be considered are: assigned WHOs, assigned queues, authorizations, execution environment, priority, last starting date, resource type qualifications and WHO status.

Influencing parameters on WHO selection:

Assigned WHO—The supervisor can assign any available WHO to a resource, even from queue which is not assigned to the resource. The system will provide a warning if the resource is not assigned to the WHO queue.

Assigned queues—Resource is assigned to resource group, which maintains sequence of assigned queues. In addition, authorization at queue level is maintained for the user. The resource queue assignments together with the authorizations of the user, determine the relevant queues for the resource.

WHO selection 110 is done by the queue sequence, as defined by the resource group assigned to the resource. Initially, the first queue will be checked and if no WHO could be selected, the following queue to be searched is the next one in the sequence with the appropriate execution environment.

The warehouse supervisor may assign the resource to a specific queue at any given time. WHO selection is such case will be done first from the assigned queue and if failed, the selection will continue by the standard procedure (i.e. by queue sequence, as described above).

On the other hand, WHO are assigned to queues. The assignment is done in the following manner: TOs are assigned to queues, which are one of the influencing parameters on WHO generation. The relationship between WHO and queue must be 1:1, therefore all the TOs, which are grouped under the same WHO, must belong to the same queue. This queue is updated as an attribute of the WHO by the WHO package, during the WHO creation process.

Execution environment 140—The queue maintains an indictor regarding the execution environment (i.e. RF/Non-RF environment). The WHO inherits this indicator from the assigned queue. WHO execution can take place in:
RF environment, triggered by the resource, who activates a logical transaction from the menu.
Non-RF environment, triggered by authorized users, who activate desktop transactions.

WHO selection is in synch with the resource's operating environment In case where resource is assigned to both RF and Non-RF queues, transition between environments is enabled whenever the user logs on or logs off or whenever the manager changes the operating environment from the monitor.

Last starting date—Last starting date (LSD) is a timestamp, which indicates the latest time in which the WHO execution should start to meet the required due date. It is an essential parameter that plays a role in WHO selection. The calculation consists of the following parameters:
Due Date (DD): Timestamp provided by the WHO (Warehouse time zone);
Picking and Placements duration (PP_DUR): Duration and Duration UOM provided by the WHO;
Movements duration of the WHO path (MOVE_DUR): The movements are resource type dependent. The duration is computed based on the walking sequence, which is determined by the sequenced TOs within the WHO. This sequence defines the sequence of the path's stopping points, which are actually bins (duplicate bins should be ignored). Each bin maintains its x,y,z coordinates. The distance is calculated between each two consecutive bins.

The LSD is calculated as follows:

LSD=DD−(MOVE_DUR+PP_DUR)

wherein MOVE_DUR is resource type dependent due to the different velocity of resource types. The maximum MOVE_DUR will be chosen for LSD calculation, to ensure support of worst case scenario.

The LSD is rounded based on the required pre-defined resolution. The resolution is defined in time intervals. The goal is to define these intervals with the maximum acceptable value that will reflect the actual required resolution for decision making concerning WHO. This will improve the performance on WHO selection. Rounding intervals are determined at mode resolution in a corresponding table.

The calculated LSD can be overridden manually from the monitor.

Resource type qualifications—Resource is associated with a specific resource type, which determines implicitly its qualifications. The qualifications are reflected in the values of the priority parameters and eventually in one number, which is the calculated priority value.

Priority model—An essential parameter for WHO selection 110 is the WHO priority. In unit 120, the WHO is prioritized based on the following parameters 220, 240, 260:
Warehouse process type;
Bin access type;
HU type group.

HU denotes the handling unit, which consists, in the frame of warehouse management, of packaging material and the good contained therein. The warehouse process type is a parameter which reflects the way an item is treated in the warehouse processes to be performed, e.g., emergency, replenishment, scrap. A numeric value is assigned to warehouse process type (from 1-10) as an attribute of its own definition. The same type of numeric value is maintained for the other two parameters (bin access type and HUType group) in the resource management system 1 (at resource type level). In case where no execution priority value is maintained for the resource type it is interpreted such that the resource type is not qualified.

A functionality 120 is provided where each parameter is weighted (from 1-100) to reflect its importance within the overall priority. Weights may vary during the day, among working days or even they may be dependent on the activity type. This variation is reflected in mode, which maintains weights for the relevant parameters.

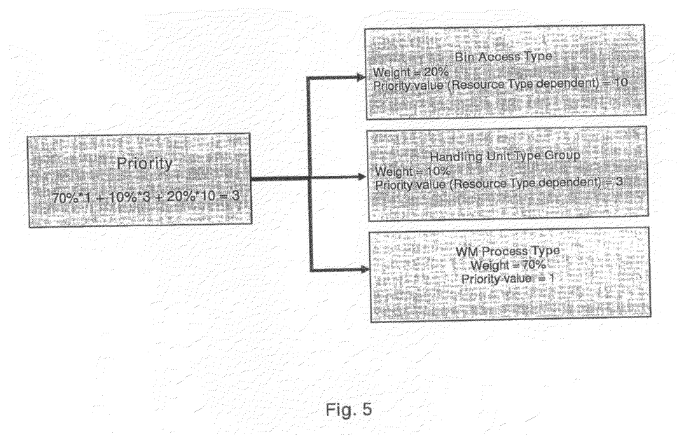

FIG. 5 gives an example for computing the calculation of the WHO priority parameter.

WHOs may have 1: m relationship with each one of the prioritizations parameters. The prioritization may be calculated for all the combinations. The maximum priority value is the selected value that will be maintained for the WHO. This ensures support of worst case scenario. The calculated execution priority of WHO per resource type can be overridden manually from the monitor.

Selection-related authorizations—In RF-environment selection is initiated by activation of logical transaction by the resource. authorization to activate logical transactions is maintained for the users. In non-RF environment the authorizations are maintained by physical transactions (i.e. desktop transactions).

WHO statuses—Relevant WHOs for selection are WHOs, which were released for execution and available (i.e. not in restricting statuses such as “hold”). The only relevant WHO status is “AVAILABLE” or “STARTED” (if the requesting resource had started the execution).

Limited population/manual selection—The user may select a specific WHO by scanning a specific HU or by specifying WHO number. The system will check to which WHO the scanned HU corresponds, and will assign the entire WHO to the resource. The WHO must be part of the relevant WHO population. Another valid option is selection of specific queue.

WHO selection process—The population of WHOs for selection is analyzed in two sequential stages:

The initial population to be checked consists of WHOs that comply with the following conditions:
WHOs, which were assigned to the resource by the manager, and have the appropriate operating environment (i.e. RF or non-RF environment). Resource that operates in RF environment can get only RP WHOs, whereas desktop resource that operates in non-RF environment may get WHOs that belong both environments.
WHOs with relevant statuses—WHO, which were released for execution and are in status “AVAILABLE” or “STARTED”.
Limited population as selected by the resource (i.e. by queue)—The resource has an option to select focused population. When this option is utilized, this condition must be fulfilled as well.

The second population to be checked is the remaining WHOs, which fully satisfy the following conditions:
WHOs which belong to one of the resource's assigned queues. The assigned queues are determined by the queues, which are assigned to the resource group and by the user's queue authorizations.
WHOs which are assigned to queues that have the appropriate operating environment (i.e. RF or non-RF environment).
WHOs which can be executed by the requesting resource type.
WHOs with relevant statuses: WHOs which were released for execution and are in status “AVAILABLE”.
Limited population as selected by the resource (i.e. by queue)—The resource has an option to select focused population.

Both populations may be analyzed based on the following parameters:
Assigned queue and queue sequence
Last starting date (LSD)
WHO priority.

WHO selection is time critical mostly in RF environment where resource idle time due to poor selection performance should be minimized. Therefore, a table that maintains the optional resource types for warehouse order execution is searched using indexes. Search by indexes provides faster access to the data records of the table. The table is frequently accessed in a way that does not take advantage of the sorting of the primary index for the access. Thus, secondary index that satisfies search criteria for each WHO population should be used for faster search in this table. Almost no manipulation has to be done on selection. Most of the influencing parameters are manipulated on WHO creation process and maintained in the table. Below are the timing details of all the parameters that influence the selection process:
Assigned WHOs are defined by manager prior to the selection and maintained in the table.
Assigned queues: Assignment of WHO to queues are determined at WHO creation and maintained in the table. Initially the selection is done from the resource's assigned queue (if determined by the manager) and only if no WHO could be selected, the selection process proceeds by the predefined queue sequence, authorization and execution environment.
Execution Environment: Execution environment is determined on WHO creation. Resource execution environment is maintained in the table until the user logs-off.
Last Starting Date: Calculated by the resource management on WHO creation process and maintained in the table.
Resource type qualifications and priority: Reflected in the priority value, which is calculated by the resource management on WHO creation process and maintained in a particular table.
Selection-Related Authorizations: They are checked prior to selection.
WHO statuses.
Limited Population/Manual Selection: The population can be limited only by queue or by manual selection of HU. Manual selection of HU requires only check to verify if the resource is assigned to the corresponding WHO's queue.

WHO assignment in RP environment—WHO assignment to resources can be done in manual or automatic modes. The supervisor typically utilizes manual mode, whereas automatic mode is used to assign WHOs to resources automatically, whenever they request for WHO assignment or continuously (after each WHO confirmation).

Authorized supervisor/manager may un-assign/assign WHOs from/to resources using the monitor. Such assignment will result in updating the WHOs with the assigned resource and indication of manual assignment. This indicator will prevent the removal of the assigned resource whenever he deselects the WHOs (i.e. utilizes the BACK functionality before starting the execution). In addition manual assignment will update the assigned resource in a table for all records that are associated with the specified WHO (i.e. all optional resource types). This will prevent assignment of other resources to the specific WHO.

WHO assignment can be done automatically following logon (optional) and WHO confirmation.

In case where the user chooses to un-assign the WHO he had started, the WHO will be split One WHO will be confirmed with the logged-off resource and the second WHO will be in status “AVAILABLE”. WHOs that were assigned to the resource by the manager will always remain assigned, unless the manager himself removes the assignment.

Analysis of WHO population is not a mandatory process. The resource may select a specific WHO by scanning a specific HU or by specifying WHO number. The system will check to which WHO the scanned HU corresponds, and will assign the entire WHO to the resource.

Assignment in non-RF environment—The WHO in non-RF environment is flagged to indicate that it is designated for printing. Assignment can be done in one of the following scenarios:

Scenario 1:
After WHO printing the supervisor gives the papers (e.g. pick list/labels) to a specific user and uses a desktop transaction to associate (assign) the WHO to the user. The assignment is traced with timestamp and allows rough control over WHO execution.

Scenario 2:
Whenever a user takes the papers (e.g. pick list/labels) he uses a desktop transaction to associate the WHO to himself the same manner, which was mentioned above for the supervisor.

In non-RF environment, multiple WHOs can be printed at once. The printing's timestamp is updated at the WHO header level. Re-printing is enabled followed by warning to indicate that the WHO was already printed.

WHO execution 140—WHOs are the execution units for the resources. As such, WHO may group various entities that represent work in the warehouse (e.g. TO processing 20, inventory counting 30, packing etc).

User and resource are both traced at TO level and WHO level.

The following updates should be done during execution (after assignment until confirmation): At the first WHO confirmation, the status of the WHO is updated to “STARTED” in the document itself and in a table for the appropriate resource type record. In addition the “Start timestamp” is captured at the document level (i.e. WHO document). When the WHO execution is completed, the status of the WHO is updated to “COMPLETED” in the document itself and the “End time-stamp” is captured. All the corresponding WHO entries are deleted from the table for the resource type record.

Warehouse order creation 120—At the creation of WHO, resource management is called to manipulate all the relevant parameters that impact the selection process. The manipulations of these parameters are maintained in corresponding tables. The parameters are:
Optional resource types 250 who are qualified to execute the WHOs;
Execution priority 240, 260 for the optional resource types;
WHO's queue;
Execution environment of WHO;
Last starting date;
Status.

Change Management 150 has the following function:
Cancelled: If a WHO is cancelled, the corresponding WHO entries are deleted from the corresponding tables.
WHO on Hold: WHO which was put on hold, are updated with “HOLD” status in all the WHO entries in the corresponding tables.
Un-hold WHO: WHOs which were un-held, are updated with “AVAILABLE” status in all the WHO entries in the corresponding tables.

Resource messages 230—The monitor 3 enables a convenient communication method of managers with RF users by pushing messages. The messages are maintained per resource by message creation timestamp or by specified timestamp as determined by the manager (if the message should not be displayed immediately to the resource). The user who created the message is traced per message. As soon as the message is displayed to the resource, all the predecessor messages are deleted from the corresponding table. Thus the monitor is able to display at any given time the last displayed message, utilizing a reserved function key.

The manager is able to generate pool of messages which are frequently used. This allows quick creation of resource messages.

Resource controlling and monitoring is enabled from the monitor 3. The following options are offered to the manager:
View of logged-on resources in RF and non-RF environment: The report consists of the resources with the corresponding logged on users, logon timestamp, status, current queue and WHO.
View of resource workload: Resources' assigned queues with the corresponding WHO. The WHO will be grouped by one of the following parameters: Activity area, LSD and priority.
View of queues: Similar to the view of resource workload but from a queue perspective. This view consists of the WHOs per queue and all the potential resource types and resources for execution.
View of users: The report displays all the potential users. Users who are logged on to resource/s will be presented with their corresponding resources.
Resource/users query by timestamps and activity areas: This query presents WHOs that were executed by the resource/user within the required timestamp interval grouped by activity areas.
Resource query by timestamp: This query presents the resource statuses and logged on users within the required time interval.
The following functionalities are enabled from the monitor:
   Resource assignment to WHO.
   Resource un-assignment from WHO.
   Logging on users in non-RF environment.
   Moving WHO from one queue to another (e.g. when WHO is moved from RF environment or vice-versa). Only violation of bin access type will be checked.
   Resource assignment to resource group for changing queue assignments.
   Change resource groups' queue assignments.
   Override WHO priority for specified resource types.
   Override LSD priority for specified resource types.

Services provided for the WHO management system:
WHO Creation: On WHO creation, resource management is addressed to manipulate all the relevant parameters for WHO selection and maintain these parameters in the corresponding table.
Change WHO: On any attempt to change a WHO (such as delete/hold/unhold) the resource management is addressed in order to check whether the execution of the WHO had not started and to make the appropriate updates in the corresponding tables.

In the following, several tables used in this invention are described. It is to be noted that an entity may be represented by multiple tables, even if it is denoted as “table” in singular.

Resource is a table which represents equipment or user, which executes work at the warehouse. On Logon in RP environment the user is updated by the application. In non-RF environment the user does not have to be system user. Records are maintained only for equipments and not for the operating human resource (resource defined as location). But, in case the user works w/o equipment, there will be an entry for the user name.

One presentation device can be a default to more than one equipment.

An entry in the resource catalog is made for both RF user and desktop user to enable user assignment to queues. While resource is assigned to resource group, queues are also assigned to resource Group and thus interlink between resource and queue is established.

Resource type is a table which enables grouping of resources by similar technical or physical qualifications. Resource type is used for priority and LSD computation.

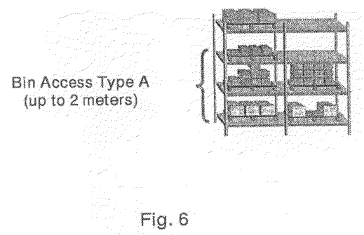

Bin access type is a table which reflects the resource type capabilities to access stock which is located in specific type of physical area (e.g. first level). FIG. 6 illustrates an example for such a bin access type. This table serves as a catalog, which maintains all the possible bin access types. Each bin is categorized into one of the bin access types. This information is required for the WHO prioritization, which is done per resource type.

TB1N_AT_PR is a table which maintains the priority value of bin access type (BIN_AT) per resource type. When the prioritization takes place, the relevant BIN_ATs are identified and priority values are retrieved for all the relevant resource types.

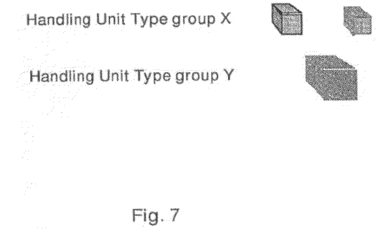

HUType group is a table which represents group of HU types, which require similar handling requirements (e.g. Big HU, Small HU). FIG. 7 illustrates an example for a particular handling unit group. This table serves as a catalog, which maintains all the possible HUT groups. Each HU type is categorized into one of the HUT Groups. This information is required for the WHO prioritization, which is done per resource type.

Table 210 maintains all the optional resource types, which can execute a specific WHO. In addition, it holds all the relevant parameters that are vital for WHO selection, to assure best performance with minimum manipulations at the WHO selection phase.

A further table is provided which determines the rules for searching an appropriate queue for a specific transfer order (TO). The initial search will be for an entry with all the relevant parameters' values, given by the TO. If this fails the queue determination table will be read again with the wildcards as determined by the access sequence table.

Table 200 traces the user's statuses and their corresponding timestamps. In addition, it maintains the resource to which the user was logged on.

Table 220 holds the execution priority weights for the relevant priority parameters. The weights may vary by mode and resource type.

Resource messages which are generated by managers from the monitor, are maintained in a table 230 by the timestamp of creation or by the timestamp specified by the message sender. Following each display of message, all the predecessor messages for the resource will be deleted. Only the last message and the messages that were not displayed will be kept.

Optionally, a message pool table is provided. Message creation and maintenance can be done from the monitor. Messages may be generated for a specific language. It is a tool to simplify message generation for resources which is advantageous for frequently used messages.

The present techniques can be implemented in digital electronic circuitry, or in computer hardware, firmware, software, or in combinations of them. Apparatus of the invention can be implemented in a computer program product tangibly embodied in a machine-readable storage device for execution by a programmable processor. Method steps according to the invention can be performed by a programmable processor executing a program of instructions to perform functions of the invention by operating on the basis of input data, and by generating output data. The invention may be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories, in particular from read-only memories and/or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in ASICs (application-specific integrated circuits).

The computer systems or distributed computer networks as mentioned above may be used, for example, for producing goods, delivering parts for assembling products, controlling technical or economical processes, or implementing telecommunication activities.

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link Such a communication link may be a serial link, a parallel link, local area network, or wireless link (e.g. an RF communication link). A display is coupled to an interface, which is coupled to an I/O bus. A keyboard and pointing device are also coupled to the I/O bus. Alternatively, separate buses may be used for the keyboard pointing device and I/O interface.

Other embodiments are in the scope of the following claims.

1. A computer-implemented warehouse order processing method, whereby a warehouse order specifies work which is to be executed by a resource at a warehouse, a resource representing a physical entity which is able to execute work;
during creation of a warehouse order, performing a step of determining a number of parameters relevant for execution of the respective warehouse order, and storing the determined parameters in a data base;
during selection of a warehouse order for execution by a requesting resource, performing a step of analyzing relevant population of warehouse orders for execution by the requesting resource, on the basis of the determined parameters, and
upon execution of a warehouse order by a resource, updating the data base comprising the parameters for the warehouse orders.

2. The method of claim 1, wherein a resource is one of single user, single warehouse equipment, and user who operates a predefined equipment.

3. The method of claim 1, wherein the parameters relevant for execution of the warehouse order comprise at least one of:
resource types which are qualified to execute the respective warehouse order,
execution environment of the respective warehouse order,
prioritization of the respective warehouse order,
last starting date of execution of the respective warehouse order, and
status of the respective warehouse order.

4. The method of claim 1, wherein each resource can be logged on, and logged off in a warehouse management system.

5. The method of claim 5, wherein at logon of a user with a work equipment, it is verified whether the user is allowed to operate the work equipment.

6. The method of claim 4, wherein at logoff of a user, it is verified whether or not the user has completed the warehouse orders assigned to him.

7. The method of claim 1, wherein warehouse orders are selected based on a number of predefined parameters.

8. The method of claim 1, wherein warehouse orders are assigned to a resource for execution upon request of the resource.

9. The method of claim 1, wherein warehouse orders are assigned to a resource for execution manually.

10. The method of claim 1, wherein warehouse orders are assigned to a resource for execution automatically.

11. The method of claim 1, wherein assignment of a warehouse order to a resource is transmitted via RF communication and outputted on an RF device which is associated with the resource.

12. The method of claim 1, wherein messages are sent to predefined resources via RF.

13. The method of claim 1, wherein logged-on resources are monitored at a central position.

14. The method of claim 1, wherein workload for a given resource is monitored at a central position.

15. The method of claim 1, wherein warehouse orders assigned to a resource are automatically recovered after execution interruption to allow further execution.

16. A computer-readable storage medium comprising program code for performing the method according to claim 1, when loaded into a computer system.
